(19) United States
(12) Patent Application Publication
(10) Pub. No.: US 2006/0133978 A1
(43) Pub. Date: Jun. 22, 2006

(54) Method of making crystalline inorganic particles

(75) Inventors: Darryl Stephen Williams, Clifton Park, NY (US); Sergio Paulo Martins Loureiro, Saratoga Springs, NY (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: General Electric Company

(21) Appl. No.: 11/019,341

(22) Filed: Dec. 21, 2004

(51) Int. Cl. C09K 11/08

(52) U.S. Cl. 423/263; 252/301.4 R; 252/301.4 S; 252/301.6 R; 252/301.6 S

(57) ABSTRACT

A method of making crystalline inorganic particles having an average size of up to about 200 nm is disclosed. The crystalline inorganic particles include at least one crystalline inorganic chalcogenide and combinations thereof. Each crystalline inorganic particle includes at least one crystallite. The method includes the steps of: providing an organometallic precursor, wherein the organometallic precursor includes at least one of a metal alkoxide, a metal carboxylate, and combinations thereof; decomposing the organometallic precursor at a first temperature for a sufficient time to form an inorganic amorphous material; and crystallizing the inorganic amorphous material at a second temperature for a sufficient time to form a crystalline phase. Also disclosed are crystalline inorganic particles made by the method.

### BACKGROUND OF THE INVENTION

This invention generally relates to a method of making crystalline inorganic particles. More specifically, the invention relates to a method of making crystalline inorganic particles having an average size of up to about 200 nm.

Several methods are known for making crystalline inorganic particles such as sol-gel techniques, spray pyrolysis, combustion, hydrothermal methods, aqueous precipitation, micellar, colloidal techniques, steric entrapment, and double-jet precipitation at low temperatures.

However, most known methods of making crystalline inorganic particles exhibit a correlation between the size of the crystalline inorganic particles and degree of crystallinity. The crystalline inorganic particles are initially either amorphous or have low crystallinity. Crystallinity may readily be obtained by calcining at high temperatures. However, calcining the crystalline inorganic particles causes sintering and or grain growth of the crystallites. As a result, known methods either produce large crystalline inorganic particles or crystalline inorganic particles that either have low or no crystallinity.

Thus, a need still remains for a method of making crystalline inorganic particles that solve at least some of the disadvantages listed above. Particularly, a need still remains for a method of making crystalline inorganic particles having an average size of up to about 200 nm.

### SUMMARY OF THE INVENTION

Accordingly, an aspect of the invention is to provide a method of making crystalline inorganic particles having an average size of up to about 200 nm. The crystalline inorganic particles comprise at least one crystalline inorganic chalcogenide and combinations thereof. Each crystalline inorganic particle comprises at least one crystallite. The method comprises the steps of: providing at least one organometallic precursor, wherein the at least one organometallic precursor comprises at least one of a metal alkoxide, a metal carboxylate, and combinations thereof; decomposing the at least one organometallic precursor at a first temperature for a sufficient time to form an inorganic amorphous material; and crystallizing the inorganic amorphous material at a second temperature for a sufficient time to form a crystalline phase.

A second aspect of the invention is to provide crystalline inorganic particles having an average size of up to about 200 nm made by a method. The crystalline inorganic particles comprise at least one crystalline inorganic chalcogenide and combinations thereof. Each crystalline inorganic particle comprises at least one crystallite. The method comprises the steps of: providing at least one organometallic precursor, wherein the at least one organometallic precursor comprises at least one of a metal alkoxide, a metal carboxylate, and combinations thereof; decomposing the at least one organometallic precursor at a first temperature for a sufficient time to form an inorganic amorphous material; and crystallizing the inorganic amorphous material at a second temperature for a sufficient time to form a crystalline phase.

### BRIEF DESCRIPTION OF THE DRAWINGS

FIG. 1 is a scanning electron microscopic image (SEM) of crystalline inorganic particles of an embodiment of the invention;

FIG. 1a is a transmission electron microscopic image (TEM) of a crystalline inorganic particle formed by crystallites of an embodiment of the invention

FIG. 2 is a schematic representation of a method of making crystalline inorganic particles of an embodiment of the invention;

FIG. 3 is a flow chart of making crystalline inorganic particles of an embodiment of the invention;

FIG. 4 is a schematic representation of a method of making crystalline inorganic particles of an embodiment of the invention;

FIG. 5 is an x-ray diffraction pattern of crystalline inorganic particles of an embodiment of the invention having an average crystallite size of 8 nm;

FIG. 6 is an x-ray diffraction pattern of crystalline inorganic particles of an embodiment of the invention having an average crystallite size of 6 nm;

FIG. 7 is an x-ray diffraction pattern of crystalline inorganic particles of an embodiment of the invention having an average crystallite size of 22 nm;

FIG. 8 is an x-ray diffraction pattern of crystalline inorganic particles of an embodiment of the invention having an average crystallite size of 77 nm; and

FIG. 9 is an x-ray diffraction pattern of crystalline inorganic particles of an embodiment of the invention having an average crystallite size of 83 nm.

### DETAILED DESCRIPTION OF THE INVENTION

In the following description, like reference characters designate like or corresponding parts throughout the several views shown in the figures. It is also understood that terms such as “top,” “bottom,” “outward,” “inward,” and the like are words of convenience and are not to be construed as limiting terms.

Whenever a particular embodiment of the invention is said to comprise or consist of at least one element of a group and combinations thereof, it is understood that the embodiment may comprise or consist of any of the elements of the group, either individually or in combination with any of the other elements of that group. Furthermore, when any variable occurs more than one time in any constituent or in formula, its definition on each occurrence is independent of its definition at every other occurrence. Also, combinations of substituents and/or variables are permissible only if such combinations result in stable compounds.

Reference will now be made in detail to exemplary embodiments of the invention, which are illustrated in the accompanying figures and examples. Referring to the drawings in general, it will be understood that the illustrations are for the purpose of describing a particular embodiment of the invention and are not intended to limit the invention thereto.

The singular forms “a”, “an” and “the” include plural referents unless the context clearly dictates otherwise.

“Optional” or “optionally” mean that the subsequently described event or circumstance may or may not occur, and that the description includes instances where the event or circumstance occurs and instances where it does not.

Any reference to elements of Groups of the Periodic Table are made in reference to the Periodic Table of the Elements, as published in “Chemical and Engineering News”, 63(5), 27, 1985. In this format, groups are numbered from 1 to 18.

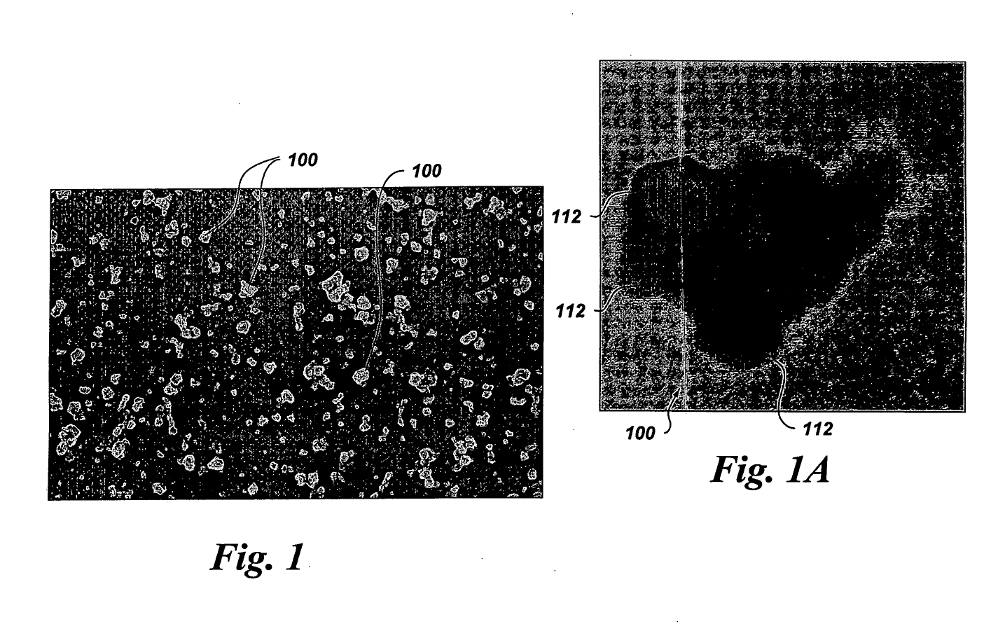

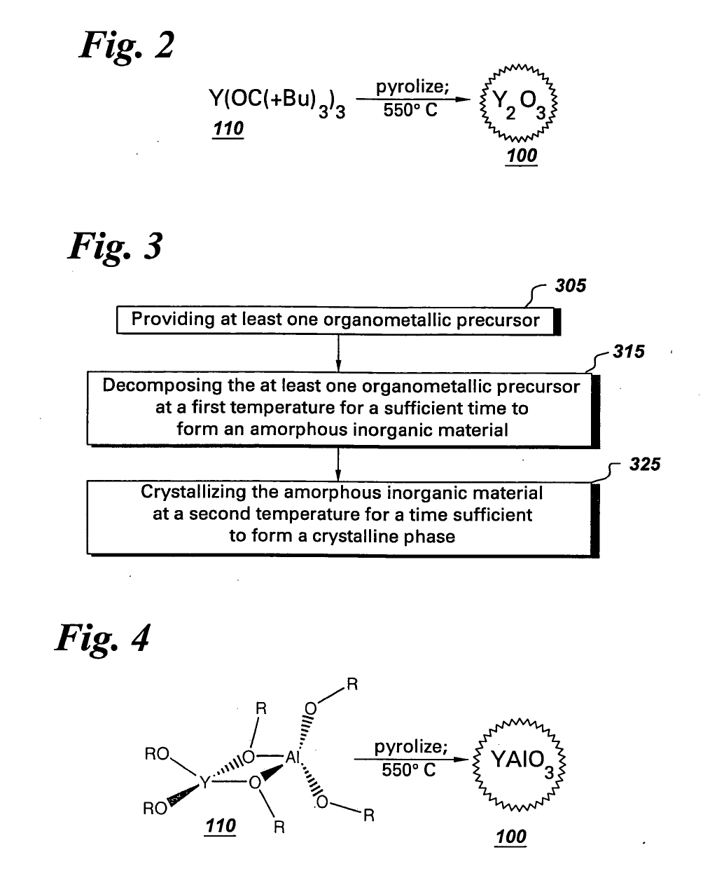

FIG. 1 is a scanning electron microscopic image (SEM) of crystalline inorganic particles 100 having an average size of up to about 200 nm. The crystalline inorganic particles 100 comprise at least one crystalline inorganic chalcogenide and combinations thereof. Each crystalline inorganic particle 100 comprises one or more crystallites 112. In one embodiment, the crystalline inorganic particle 100 is formed by several crystallites 112, as shown in FIG. 1a, which is a TEM image of a crystalline inorganic particle 100. With reference to FIG. 2, methods of making the crystalline inorganic particles 100 are described. FIG. 2 is a schematic representation of a method of making crystalline inorganic particles 100 and FIG. 3 is a flow chart of a method of making crystalline inorganic particles 100.

As described in FIG. 3, the method comprises, at Step 305, providing at least one organometallic precursor 110. The organometallic precursor 110 either individually comprises at least one of a metal alkoxide, a metal carboxylate, or in any combinations thereof.

In one embodiment of the Step 305 of providing the organometallic precursor 110, Step 305 comprises providing a metal alkoxide. The metal alkoxide comprises M(OR)ₙX₍ₘ₋ₙ₎Lₚ. M is a metal, wherein the metal comprises an electropositive element of Groups 1-15. Each X is independently a mono-anionic ligand selected from a group consisting of O_{1/2}, F, Cl, Br, I, OR, O₂CR, NR₂, and R. Each R is independently a hydrocarbyl group. Each L is independently a Lewis base ligand. n is equal to ½ the oxidation state of the metal M in the product particle. m is equal to the oxidation state of M in the compound M(OR)ₙX₍ₘ₋ₙ₎Lₚ and p≧0.

Examples of the metal M include, but are not limited to, alkali metals such as Li, Na, K, Rb, or Cs, either individually or in any combination thereof; alkaline earths such as Mg, Ca, Sr, or Ba, either individually or in any combination thereof; transition metals of groups 3 through 12 such as Y, Ti, Zr, Nb, Ta, W, or Zn, either individually or in any combination thereof; rare earths such as Ce, Pr, Nd, Dy, Tb, Eu, Gd, Er, or La, either individually or in any combination thereof; metalloids such as B, Al, Ga, In, Sn, or Pb either individually or in any combination thereof. Particular examples of the metal M include, but are not limited to, acetate, laurate, stearate, 2-ethylhexanoate, and neodecanoate salts of Na, Ca, Ba, Y, Ti, Zr, Nb, Zn, B, Al, Si, Ge, and Sn, Ti(laurate)₂(OiPr)₂, Ti(laurate)₂(OMe)₂, Zr(laurate)₂(OiPr)₂, Hf(laurate)₂(OiPr)₂, B₃O₃(OAc)₃, Al(OAc)₃, Bu₂Sn(OAc)₂Si(OR)₄, Ti(OR)₄, Zr(OR)₄, NaOAc, Ca(OAc)₂, Ba(OAc)₂, Y(OAc)₃, Ti(OMe)₂(OAc)₂, Ti(OiPr)₂₋(OAc)₂, Zr(OiPr)₂(OAc)₂, Nb(OAc)_{5/2}(OEt)_{5/2}, W(O)(OAc)₂(OEt)₂, Re(O)(OAc)₃py₂, Zn(OAc)₂ and B(OAc)₃. In one embodiment, the Step 305 of providing the organometallic precursor 110 comprises a combination of metal M wherein the organometallic precursor 110 is polymetallic, as in FIG. 4 which is another schematic representation of a method of making crystalline inorganic particles 100. Examples of polymetallic precursors include any combination of two or more metals (M) as described herein above, such as a combination of Y and Al.

In one embodiment, X comprises an alkoxide of the form OR. The alkoxide either individually comprises at least one of methoxide, ethoxide, i-propoxide, n-butoxide, t-butoxide, phenoxide, 2,6-dimethylphenoxide, trifluoromethoxide, trifluoroethoxide, hexafluoro-i-propoxide or in any combination thereof. In another embodiment, X comprises a carboxylate of formula OC(O)R wherein the carboxylate either individually comprises at least one of formate, acetate, laurate, acetate, stearate, benzoate, pivalate, or in any combination thereof.

In another embodiment, X comprises an amide of the form NR₂. The amide comprises, either individually or in any combination thereof, at least one of dimethylamide, diethylamide, di-n-propylamide, di-i-propylamide, diphenylamide, bis-2,6-dimethylphenylamide, bis-2,6-di-i-propylphenylamide, N-methylanilide, and the like, heterocyclic amides such as the conjugate bases of pyrrole, pyrrolidine, piperidine, piperazine, indole, imidazole, azole, thiazole, purine, phthalimide, azacycloheptane, azacyclooctane, azacyclononane, azacyclodecane, their substituted derivatives, and the like.

In another embodiment, X comprises an alkyl of the form R. R comprises, either individually or in any combination thereof, at least one of methyl, ethyl, propyl, butyl, dodecyl, tetradecyl, hexadecyl, phenyl, 2,6-dimethylphenyl, benzyl, neopentyl, or any hydrocarbyl group.

A hydrocarbyl group denotes a monovalent, linear, branched, cyclic, or polycyclic group containing carbon and hydrogen atoms, the hydrocarbyl group optionally containing atoms in addition to carbon and hydrogen, atoms selected from Groups 15, and 16 of the Periodic Table and further containing C₁-C₃₀ alkyl; C₁-C₃₀ alkyl substituted with one or more groups selected from C₁-C₃₀ alkyl, C₃-C₁₅ cycloalkyl or aryl; C₃-C₁₅ cycloalkyl; C₃-C₁₅ cycloalkyl substituted with one or more groups selected from C₁-C₂₀ alkyl, C₃-C₁₅ cycloalkyl or aryl; C₆-C₁₅ aryl; and C₆-C₁₅ aryl substituted with one or more groups selected from C₁-C₃₀ alkyl, C₃-C₁₅ cycloalkyl or aryl group; wherein aryl denotes a substituted or unsubstituted phenyl, naphthyl, or anthracenyl group.

In another embodiment of the Step 305 of providing an organometallic precursor 110, Step 305 comprises providing a metal carboxylate. The metal carboxylate comprises M(O₂CR)ₙX₍ₘ₋ₙ₎Lₚ. M is a metal wherein the metal comprises an electropositive element of Groups 1-15. Each X is independently a mono-anionic ligand selected from a group consisting of O_{1/2}, F, Cl, Br, I, OR, O₂CR, NR₂, and R. Each R is independently a hydrocarbyl group. Each L is independently a Lewis base ligand. n is equal to ½ the oxidation state of the metal M in the product particle. m is equal to the oxidation state of M in the compound M(O₂CR)ₙX₍ₘ₋ₙ₎Lₚ and p≧0.

In one embodiment, X comprises an alkoxide of the form OR wherein the alkoxide is selected from a group consisting of methoxide, ethoxide, i-propoxide, n-butoxide, t-butoxide, phenoxide, 2,6-dimethylphenoxide, trifluoromethoxide, trifluoroethoxide and hexafluoro-i-propoxide.

In another embodiment, X comprises a carboxylate of formula OC(O)R wherein the carboxylate is selected from a group consisting of formate, acetate, laurate, acetate, stearate, benzoate and pivalate.

In another embodiment, X comprises a hydrocarbyl group denoting a monovalent, linear, branched, cyclic, or polycyclic group containing carbon and hydrogen atoms, the hydrocarbyl group optionally containing atoms in addition to carbon and hydrogen, atoms selected from Groups 15, and 16 of the Periodic Table and further containing C₁₋C₃₀ alkyl; C₁-C₃₀ alkyl substituted with one or more groups selected from C₁₋C₃₀ alkyl, C₃-C₁₅ cycloalkyl or aryl; C₃₋C₁₅ cycloalkyl; C₃₋C₁₅ cycloalkyl substituted with one or more groups selected from C₁₋C₂₀ alkyl, C₃-C₁₅ cycloalkyl or aryl; C₆-C₁₅ aryl; and C₆-C₁₅ aryl substituted with one or more groups selected from C₁-C₃₀ alkyl, C₃-C₁₅ cycloalkyl or aryl group; wherein aryl denotes a substituted or unsubstituted phenyl, naphthyl, or anthracenyl group.

The Lewis bases, as referred herein above, may be any neutral (i.e. non-ionic) compound containing at least one electronegative atom from groups 15 and 16, the atom binding to M via this atom in a dative interaction. The Lewis base may additionally be a surfactant, for the purposes of this invention.

Examples of the Lewis base L are mono- or multidentate alcohols, ethers, esters, ketones, carboxylic acid amides, amines, phosphines, phosphine oxides, phosphites, phosphates, thiols, thioethers, sulfones, sulfoxides, and the like.

Examples of Lewis base L that are alcohols include methanol, ethanol, isopropanol, octanol, decanol, dodecanol, tetradecanol, octadecanol, phenol, t-butylphenol, nonylphenol, benzyl alcohol, and the like.

Examples of Lewis base L that are ethers include tetrahydrofuran, diethyl ether, dipropyl ether, diisopropyl ether, dibutyl ether, dioctyl ether, tert-butyl methyl ether, trimethylene oxide, 1,2-dimethoxyethane, 1,2-dimethoxypropane, 1,3-dimethoxypropane, 1,2-dimethoxybutane, 1,3-dimethoxybutane, 1,4-dimethoxybutane, tetrahydropyran, and the like.

Examples of Lewis base L that are carboxylic acid esters include methyl formate; methyl acetate; ethyl acetate; vinyl acetate; propyl acetate; butyl acetate; isopropyl acetate; isobutyl acetate; octyl acetate; methyl benzoate; ethyl benzoate; dimethyl maleate; dimethyl phthalate; diethyl phthalate; and the like.

Examples of Lewis base L that are ketones include acetone; 2-butanone; pinacolone; acetophenone; benzophenone; mesityl oxide; hexafluoroacetone; perfluoro-2-butanone; 1,1,1,3,3,3-hexafloroacetone and the like.

Examples of Lewis base L that are carboxylic acid amides include formamide; acetamide; propionamide; isobutyramide; trimethylacetamide; cyclohexanecarboxamide; acrylamide; methacrylamide; 2,2,2-trifluoroacetamide; benzamide; N-methylformamide; N,N-dimethylformamide; 1-acetylpyrrolidine; 1-acetylpiperidine; 1-acetylpiperazine; and the like.

Examples of Lewis base L that are amines include ammonia; methylamine; ethylamine; propylamine; octylamine; cyclohexylamine; aniline; dimethylamine; diethylamine; dioctylamine; dicyclohexylamine; trimethylamine; triethylamine; N-methylaniline; dimethylaniline; N,N-diethylaniline; piperidine; piperazine; pyridine; morpholine; N-methylmorpholine and the like.

Examples of Lewis base L that are phosphorus compounds include saturated or unsaturated aliphatic, alicyclic, or aromatic phosphorus compounds having 2 to 50 carbon atoms containing at least one phosphorus atom. Included within the phosphorus compounds are compounds containing heteroatoms, which are atoms other than carbon, selected from Groups 13, 14, 15, 16 and 17 of the Periodic Table of Elements.

Examples of as Lewis base L that are phosphines include trimethylphosphine; triethylphosphine; trioctyl phosphine, tris(2-ethylhexylphosphine), triphenylphosphine; tri-p-tolylphosphine; tri-m-tolylphosphine; tri-o-tolylphosphine; methyldiphenylphosphine; ethyldiphenylphosphine; isopropyldiphenylphosphine; allyldiphenylphosphine; cyclohexyldiphenylphosphine; benzyldiphenylphosphine; and the like.

Examples of Lewis base L that are phosphine oxides include trimethylphosphine oxide; triethylphosphine oxide; trioctyl phosphine, tris(2-ethylhexylphosphine), triphenylphosphine oxide; tri-p-tolylphosphine oxide; tri-m-tolylphosphine oxide; tri-o-tolylphosphine oxide; methyldiphenylphosphine oxide; ethyldiphenylphosphine oxide; isopropyldiphenylphosphine oxide; allyldiphenylphosphine oxide; cyclohexyldiphenylphosphine oxide; benzyldiphenylphosphine oxide; and the like.

Examples of Lewis base L that are phosphites include trimethylphosphite; triethylphosphite; trioctyl phosphine, tris(2-ethylhexylphosphine), triphenylphosphite; tri-p-tolylphosphite; tri-m-tolylphosphite; tri-o-tolylphosphite; methyldiphenylphosphite; ethyldiphenylphosphite; isopropyldiphenylphosphite; allyldiphenylphosphite; cyclohexyldiphenylphosphite; benzyldiphenylphosphite; and the like.

Examples of Lewis base L that are phosphates include trimethylphosphate; triethylphosphate; trioctyl phosphine, tris(2-ethylhexylphosphine), triphenylphosphate; tri-p-tolylphosphate; tri-m-tolylphosphate; tri-o-tolylphosphate; methyldiphenylphosphate; ethyldiphenylphosphate; isopropyldiphenylphosphate; allyldiphenylphosphate; cyclohexyldiphenylphosphate; benzyldiphenylphosphate; and the like.

Examples of Lewis base L that are thiols include methanane thiol; ethanane thiol; isopropanane thiol; octanane thiol; decanane thiol; dodecanane thiol; tetradecanane thiol; octadecanane thiol; thiophenol; t-butylthiophenol; nonylthiophenol; benzyl thiol; and the like.

Examples of Lewis base L that are thiosulfides include tetrahydrothiophene, diethyl sulfide, dibutyl sulfide, dioctyl sulfide, tert-butyl methyl sulfide, and the like.

Examples of the Lewis base ligand L that are sulfones include methyl sulfone; ethyl sulfone; phenyl sulfone; 2-(phenylsulfonyl)tetrahydropyran; and the like.

Examples of Lewis base L that are sulfoxides include methyl sulfoxide; ethyl sulfoxide; methyl phenyl sulfoxide; benzyl sulfoxide; tetramethylene sulfoxide; and the like.

In one embodiment of the Step 305 of providing the organometallic precursor 110, Step 305 comprises providing a solution comprising the organometallic precursor 110 and a solvent. In one embodiment, the solvent comprises a non-aqueous solvent. In a particular embodiment, the non-aqueous solvent comprises an aprotic solvent. In yet a more particular embodiment, the non-aqueous solvent comprises an organic solvent. The solvent or a combination of solvents useful herein can be any liquid in which the metal compound(s) is soluble. Commonly used solvents for this purpose include hydrocarbon solvents. Exemplary solvents include hexadecane, dioctyl ether, and diphenyl ether. Other solvents useful for the present invention include aromatic and aliphatic solvents containing at least seven carbons such as dibutyl ether, didecyl ether, dodecane, tetradecane, decaline, toluene, xylenes, mesitylene, anisole, dichlorobenzenes, dimethylsulfoxide, sulfolane, and the like.

The generation and introduction into the solvent of the organometallic precursor 110, such as M(O₂CR)ₙXₙLₘ, is not limited in any way. This includes, for example, dissolution of a pure species of the metal M as well as by mixing multiple precursors. For example, mixing in situ MXₘ with a carboxylic acid anhydride (RCO)₂O, the conjugate acid of another X or the carboxylate O₂CR, a complex of X or the carboxylate O₂CR, or a salt of X or the carboxylate O₂CR, and with ligand L, when appropriate. The group L, X, or the carboxylate O₂CR may each optionally be a surfactant for the purposes of this invention.

Next, as described in FIG. 3, Step 315 comprises decomposing the organometallic precursor 110 at a first temperature to form an inorganic amorphous material. Then, Step 325 comprises crystallizing the inorganic amorphous material at a second temperature for a sufficient time to form a crystalline phase. The inorganic amorphous material is of the same or similar chemical composition of the crystalline phase to be formed. In one embodiment, the Step 315 of decomposing the organometallic precursor at a first temperature comprises a first temperature, which is greater than the second temperature of crystallizing the inorganic amorphous material. In another embodiment, the Step 315 of decomposing the organometallic precursor at a first temperature comprises a first temperature, which is the same as the second temperature of crystallizing the inorganic amorphous material. In yet another embodiment, the Step 315 of decomposing the organometallic precursor at a first temperature comprises a first temperature, which is less than the second temperature of crystallizing the inorganic amorphous material. In one embodiment, the step of heating the organometallic precursor 110 comprises heating under an inert atmosphere.

The organometallic precursor 110, such as M(O₂CR)ₙXₙLₘ, may be generated in a solvent, introduced in the solvent, or both generated and introduced in any way to the solvent prior to contact with the surfactant and optionally, the dehydrating agent, including dissolution of a pure species or by mixing, e.g., a metal alkoxide with the Lewis base (L), in situ.

In one embodiment, at least one surfactant is provided to the organometallic precursor 110. In one embodiment, the surfactant comprises an aprotic surfactant. The surfactant may used to control the size of the crystalline inorganic particles 100. Typically, the crystalline inorganic particles 100 have a variation in size distribution in a range between about −50% and about +50%. In one embodiment, the molar ratio of the surfactant to the organometallic precursor 110 is from about 0.01 to about 100. More particularly, the molar ratio of the surfactant to the metal M is from about 0.25 to about 30. Most particularly, the molar ratio of the surfactant to the metal M is from about 1 to about 10.

The surfactant useful herein can be any compound with a polar group on one end and a non-polar tail having at least six atoms. In general, surfactants may be either nonionic, ionic, or combinations thereof. The surfactant may or may not form an ionic, covalent, or dative bond with the metal compound. The surfactant may or may not form a micellar structure before, during, or after the reaction to form the oxide nanoparticles. Typically, the surfactant comprises a compound which may be expressed in the form T-H, where T is a tail group, typically a non-polar group containing 6-22 carbon atoms and optionally other atoms and H is a head group, typically a polar group which interacts with the precursor, the nanoparticle surface, or both. Examples of head groups are sulfate ((—O)₂SO₂), sulfonate (—SO₂OH), sulfinate (—SOOH), phosphate ((—O)₃PO), phosphite ((—O)₃P) phosphine (—P), phosphine oxide (—PO), phosphinate (—POOH), phosphonate —OPO(OH)₂, carboxylate (—COOH), hydroxy-terminated poly(ethylene glycol) (—O(CH₂CH₂O)H), alcohol (—OH) and thiol (—SH).

Exemplary non-ionic surfactants of the present invention include compounds of the formula OₚEX¹₃ wherein E is selected from a group consisting of N, P, and As, wherein each X¹ is independently OR¹ or R¹, and wherein each R¹ is independently hydrogen or a hydrocarbyl group, wherein p is between 0 and 1 and at least one R contains at least 6 carbon atoms.

Other non-ionic surfactants of the present invention include compounds of the formula O_{q}SX¹₂, wherein each X¹ is independently OR¹ or R¹, wherein each R¹ is independently hydrogen or a hydrocarbyl group wherein q is between 0 and 2, and wherein at least one R¹ contains at least 6 carbon atoms.

Exemplary non-ionic surfactants may also be compounds of the formula HAR², wherein A is selected from a group consisting of O and S, wherein each R² is independently a hydrocarbyl group, and wherein at least one R contains at least 6 carbon atoms.

The non-ionic surfactant may also be compounds of the formula: R²C(O)X² wherein R² is a hydrocarbyl group containing at least 6 carbon atoms, X² is selected from a group consisting of OH, NH₂, SH, and the like.

Typically, non-ionic surfactants useful herein are carboxylic acids of the formula RCOOH such as oleic acid, stearic acid, linoleic acid, lauric acid, 2-ethylhexanoic acid, azelaic acid, palmitic acid, linolenic acid, erucic acid and the like; amines such as stearyl amine, oleyl amine, erucic amine, lauryl amine and the like; alcohols such as decanol, cetyl alcohol, oleyl alcohol, stearyl alcohol, lauryl alcohol and the like; thiols such as decanethiol, dodecanethiol, tetradecanethiol, hexadecanethiol, and the like; phosphines such as trioctylphosphine, tris(2-ethylhexylphosphine, triphenylphosphine, tri-p-tolylphosphine, tri-m-tolylphosphine, tri-o-tolylphosphine, methyldiphenylphosphine, ethyldiphenylphosphine; cyclohexyldiphenylphosphine; benzyldiphenylphosphine, and the like; phosphine oxides such as trioctyl phosphine oxide, tris(2-ethylhexyl)phosphine oxide, triheptyl phosphine oxide, tripentyl phosphine oxide, tridecyl phosphine oxide and the like; phosphites such as tris(2-ethylhexyl)phosphite, trioleyl phosphite, trilauryl phosphite, tristeryl phosphite, di isodecyl pentaerythytol diphosphite, trioctyl phosphite, triphenyl phosphite, tricyclodecane dimethanol phosphite and the like; phosphates such as tris(2-ethylhexyl)phosphate, trioleyl phosphate, tristearyl phosphate, trilauryl phosphate, tributyl phosphate, trioctyl phosphate and the like; sulfoxides such as decyl methyl sulfoxide, dimethyl sulfoxide, dioleyl sulfoxide, dilauryl sulfoxide, distearyl sulfoxide and the like; sulfones such as tosyloxyphenyl sulfone, tosyloxyvinyl sulfone and the like.

The surfactant may be an ionic surfactant. For example, the surfactant may be a compound of the formula [E¹R²₄]⁺W⁻, wherein W is selected from a group consisting of F, Cl, Br, I, and OR, wherein E¹ is selected from a group consisting of N, P, and wherein each R² is independently a hydrocarbyl group, and wherein at least one R² contains at least 6 carbon atoms.

Another exemplary ionic surfactant is a compound of the formula [J]^{x+}[OᵣSX¹ₛ]^{y-} wherein J is selected from a group consisting of Li, Na, K, Rb, Cs, Be, Mg, Ca, Sr, Ba, NR₄, and PR₄, wherein each X¹ is independently OR¹ or R¹, wherein each R¹ is independently hydrogen or a hydrocarbyl group, wherein r is between 1 and 3, wherein s is between 1 and 2, wherein at least one R contains at least 6 carbon atoms, and wherein the sum of “x+” and “y−” is zero.

A further exemplary ionic surfactant is a compound of the formula [J]^{x+}[OₜPX¹ᵤ]^{y-} wherein J is selected from a group consisting of Li, Na, K, Rb, Cs, Be, Mg, Ca, Sr, Ba, NR₄, and PR₄, wherein each X¹ is independently OR¹ or R¹, wherein each R¹ is independently hydrogen or a hydrocarbyl group, wherein t is between 0 and 3, u is between 1 and 3, x is between 1 and 2, y is between 1 and 3 with the proviso that the sum of “x+” and “y−” is zero, and wherein at least one R¹ contains at least 6 carbon atoms.

Yet another exemplary ionic surfactant is of the formula: J¹AR², wherein J¹ is selected from a group consisting of Li, Na, K, Rb, Cs, Be, Mg, Ca, Sr and Ba, wherein A is selected from a group consisting of O and S, wherein R² is independently a hydrocarbyl group, and wherein at least one R² contains at least 6 carbon atoms.

Examples of ionic surfactants include compounds where the polar group is an ionic group or a salt, including sulfonates such as sodium dodecyl sulfate, sodium lauryl sulfate, sodium benzene sulfonate, sodium tolylsulfonate and the like; ammonium salts such as tetrabutyl ammonium hydroxide, tetraethyl ammonium hydroxide, cetyl trimethyl ammonium bromide, tetraphenyl ammonium hydroxide and the like; alkoxides and thiolates with counterions such as lithium, sodium, potassium, calcium, magnesium, and the like.

In some embodiments the surfactant may be a dehydrating agent. The dehydrating agents may comprise acid anhydrides, thionyl chloride, phosphorus oxides and combinations thereof.

In one embodiment, at least one promoter is provided to the organometallic precursor 110. Examples of promoters include nucleophilic promoter, as well as electrophilic promoters.

In another embodiment, at least one dopant may be provided to the organometallic precursor 110. The dopant may introduce a desired physical property into a host lattice, such as optical activity, magnetism, electrical conductivity, and ionic conductivity. In one embodiment, the dopant either individually comprises a metal, a chalcogen, or in any combination therof. In a particular embodiment, the dopant comprises a metal. The metal may either individually comprises at least one of an alkali metal, alkaline earth metal, transition metal, and rare earth metal or in any combination therof. In another embodiment, the dopant comprises a luminescent dopant.

The order of adding the components such as the organometallic precursor 110, surfactant, promoter, and dopant is not limited. Typically, the alkoxide precursor and the surfactant may be dissolved in the solvent and refluxed for an appropriate time. The time of refluxing of the reactive mixture may vary between about 10 minutes and 100 hours in one embodiment of the present invention. In a particular embodiment of the present invention, the time for refluxing varies between about 20 minutes and about 72 hours. Then, additional solvent, and/or other components may be added continuously or incrementally. In one embodiment of the present invention, the mixing may be conducted at a temperature between about 50° C. and about 350° C., while in a second embodiment the mixing may be conducted at a temperature between about 150° C. and about 250° C.

Another aspect of the invention is to provide crystalline inorganic particles 100 having an average size of up to about 200 nm made by the method discussed hereinabove. In one embodiment, the crystalline phase of the crystalline inorganic particle 100 is in a colloidal suspension. In one embodiment, the crystalline inorganic chalcogenide comprises a crystalline inorganic oxide. Examples of crystalline inorganic oxide include, but are not limited to, LaPO₄:Pr³⁺; LaB₃O₆:Pr³⁺; LaBO₃:Pr³⁺; YBO₃:Pr³⁺; GdBO₃:Pr³⁺; LuBO₃:Pr³⁺(Gd Y)B₃O₆:p³⁺; (Sr,Ca)Al₁₂O₁₉:Pr³⁺; (La,Gd,Y)MgB₅O₁₀:Pr³⁺; SrB₄O₇:Pr; CaMgAl_{11.33}O₁₉:Pr³⁺; CaMgAl₁₄O₂₃:Pr³⁺; YPO₄:Pr³⁺; GdPO₄:Pr³⁺; Y₂SiO₅:Pr³⁺; YPO₄:Bi³⁺; LuPO4:Bi³⁺; LaPO₄:Pr³⁺, Pb²⁺; LaB₃O₆:Pr³⁺Pb²⁺; LaBO₃:Pr³⁺, Pb²⁺; YBO₃:Pr³⁺, Pb²⁺; GdBO₃:Pr³⁺, Pb²⁺; LuBO₃:Pr³⁺; Pb²⁺; (Gd,Y)B₃O₆:Pr³⁺, Pb²⁺; (Sr,Ca)Al₁₂O₁₉:Pr³⁺, Pb ²⁺; (La,Gd,Y)MgB₅O₁₀::Pr³⁺, Pb²⁺; SrB₄O₇:Pr³⁺, Pb²⁺; CaMgAl_{11.33}O₁₉:Pr³⁺, Pb²⁺; CaMgAl₁₄O₂₃:Pr³⁺, Pb²⁺; YPO₄:Pr³⁺, ²⁺+; GdPO₄KPr³⁺, Pb²⁺; Y₂SiO₆:Pr³⁺, Pb²⁺; YPO₄:Bi³⁺Pb²⁺; LuPO₄:Bi³⁺Pb²⁺; LaPO₄:Pr³⁺, Pb²⁺, Bi³⁺; LaB₃O₆:Pr³⁺, Pb²⁺, Bi³⁺; LaBO₃:Pr³⁺, Pb²⁺, Bi³⁺; YBO₃:Pr³⁺Pb²⁺Bi³⁺; GdBO₃:Pr³⁺Pb²⁺Bi³⁺; LuBO₃:Pr³⁺, Pb²⁺, Bi³⁺; (Gd,Y)B₃O₆:Pr³⁺, Pb²⁺, Bi³⁺; (Sr,Ca)Al₁₂O₁₉:Pr³⁺, Pb²⁺, Bi³⁺; (La,Gd,Y)MgB₅O₁₀:Pr³⁺, Pb²⁺Bi³⁺; SrB₄O₇:Pr³⁺, Pb²⁺, Bi³⁺. CaMgAl_{11.33}O₁₉:Pr³⁺, Pb²⁺, Bi³⁺; CaMgAl₁₄O₂₃:Pr³⁺, Pb²⁺, Bi³⁺ and combinations thereof, wherein such exemplary species are shown in a form bulk oxide:dopant(s).

In one embodiment, the crystalline inorganic particles 100 have an average size in a range from about 20 nm to about 200 nm. In another embodiment, the crystalline inorganic particle 100 have an average size in a range from about 40 nm to about 100 nm. In yet another embodiment, the crystalline inorganic particles 100 have an average size in a range from about 50 nm to about 80 nm.

The average crystallite size value was determined by X-ray powder diffraction measurements and extracted through profile fitting of a given crystallographic reflection using the Scherrer equation In one embodiment, the average crystallite 112 size ranges from about 1 nm to about 80 nm. In another embodiment, the average crystallite 112 size ranges from about 4 nm to about 40 nm.

The crystalline inorganic particles 100 have utility in many areas because they form more stable colloids, scatter light less efficiently, and have a larger surface area/volume ratio than other larger crystalline inorganic particles 100. In one particular embodiment, the crystalline inorganic particle 100 at least partially comprises a part of at least one of a scintillator, phosphor, light absorber, and light scatterer. The crystalline inorganic particles 100 can also be used as fillers for modifying the following properties of a matrix to be filled: refractive index, coefficient of thermal expansion, viscosity, optical density, heat deflection temperature, fracture toughness, glass transition temperature, color, bulk density, flame retardancy, adhesion, electrical conductivity, thermal conductivity, crosslinking density, thermal stability, UV stability, and gas permeabilty. The following examples serve to illustrate the features and advantages of the present invention and are not intended to limit the invention thereto.

### EXAMPLE 1

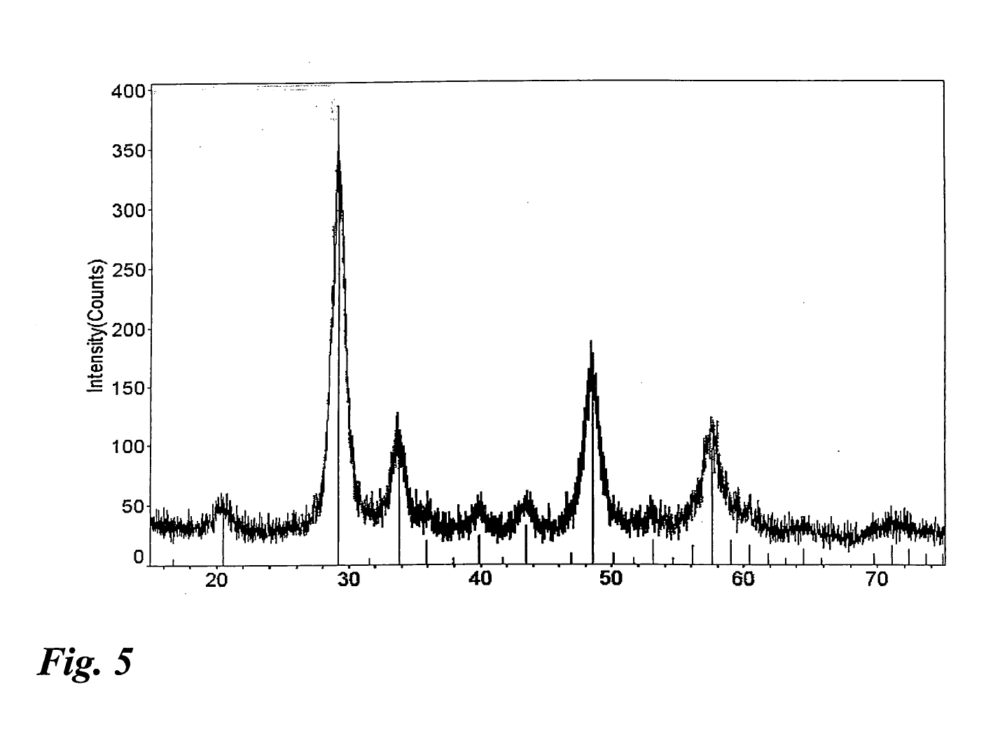

Y₂O₃. Yttrium 2-ethyl hexanoate was dissolved in Et₂O and evaporated onto a glass watch glass to provide a clear film. The film was scraped from the glass and placed into an alumina crucible, which was then placed into a high temperature oven. The sample was heated to 550° C. for 10 hrs and cooled to room temperature, leaving white powder (22% ceramic yield) which was characterized by x-ray diffraction (XRD). FIG. 5 is an x-ray diffraction pattern of the crystalline inorganic particles 100. The presence of small crystallites is clear from the breadth of the peaks in the diffraction pattern, while the high crystallinity is evidenced by alignment with the known diffraction pattern of bulk cubic yttria. Using the Scherrer equation to fit the diffraction pattern results in an average crystallite size of 8 nm.

### EXAMPLE 2

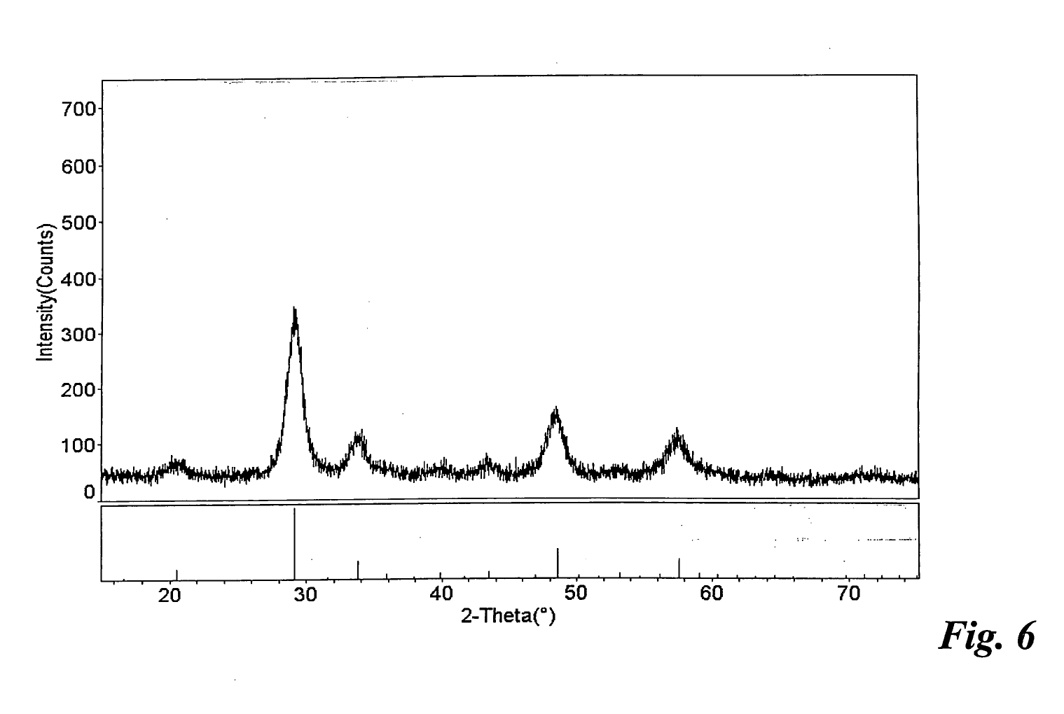

Y₂O₃:Eu³⁺. Yttrium 2-ethyl hexanoate and Europium 2-ethyl hexanoate were dissolved in tetrahydrofuran with gentle heating to form a resulting solution. The solution was poured into cold ethanol to form a white precipitate which was then isolated by filtration. When dry, the white precipitate was ground up, placed into an alumina crucible, and calcined at 550° C. for 10 hr. The white precipitate was isolated and characterized by XRD. FIG. 6 is an x-ray diffraction pattern of the crystalline inorganic particles 100. Using the Scherrer equation to fit the diffraction pattern results in an average crystallite size of 6 nm. The quantum efficiency was determined to be 34% of the standard europium-doped yttria.

### EXAMPLE 3

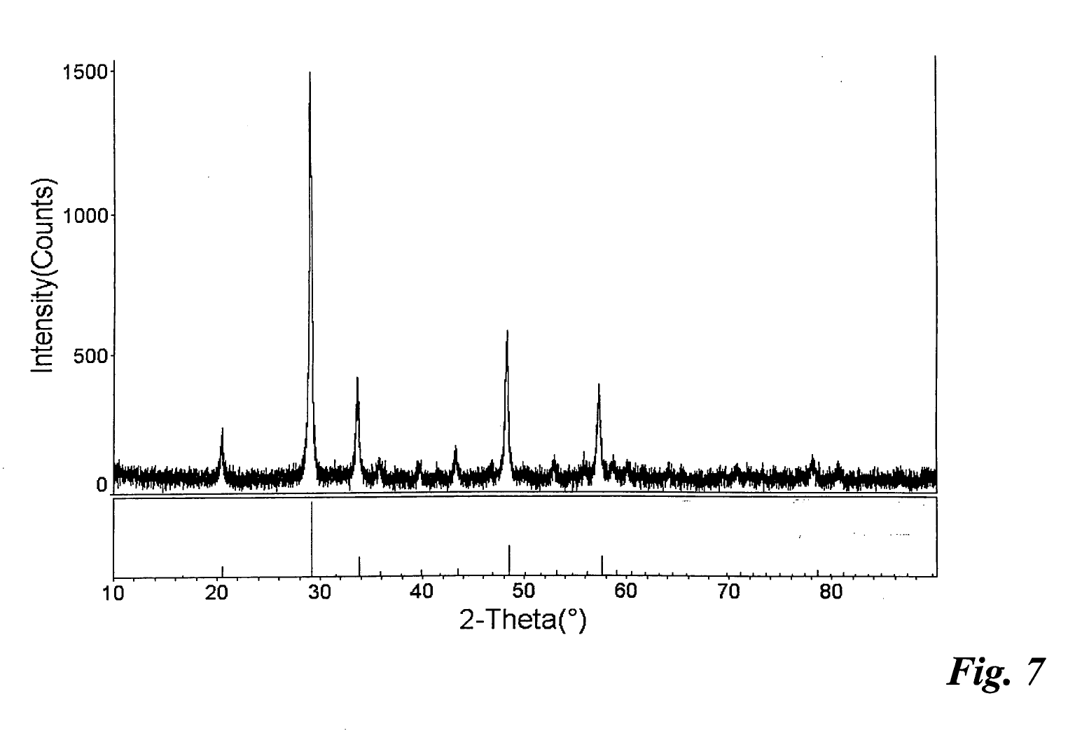

(Y_{0.66}Gd_{0.33})₂O₃:Eu³⁺. 2-Ethylhexanoic acid was dissolved in ethanol and H₂O at 70° C. in a water bath to form a solution. NaOH was added to the solution as a solid and the solution stirred until the NaOH dissolved. In a separate vial, yttrium chloride hydrate, gadolinium chloride hydrate, and EuCl₃ hydrate were dissolved in water and added dropwise to the rapidly stirred 2-ethylhexanoate solution, causing formation of a fluffy white precipitate. The reaction was stirred for 30 min and then cooled to room temperature. The white precipitate was isolated by filtration and washed with water before drying in a vacuum oven at approximately 40° C. overnight. When dry, the white precipitate was ground up, placed into an alumina crucible, and calcined at 550° C. for 10 hr. The white precipitate was isolated and characterized by XRD. FIG. 7 is an x-ray diffraction pattern of the crystalline inorganic particles 100. Using the Scherrer equation to fit the diffraction pattern of the observed cubic phase results an average crystallite size of 22 nm.

### EXAMPLE 4

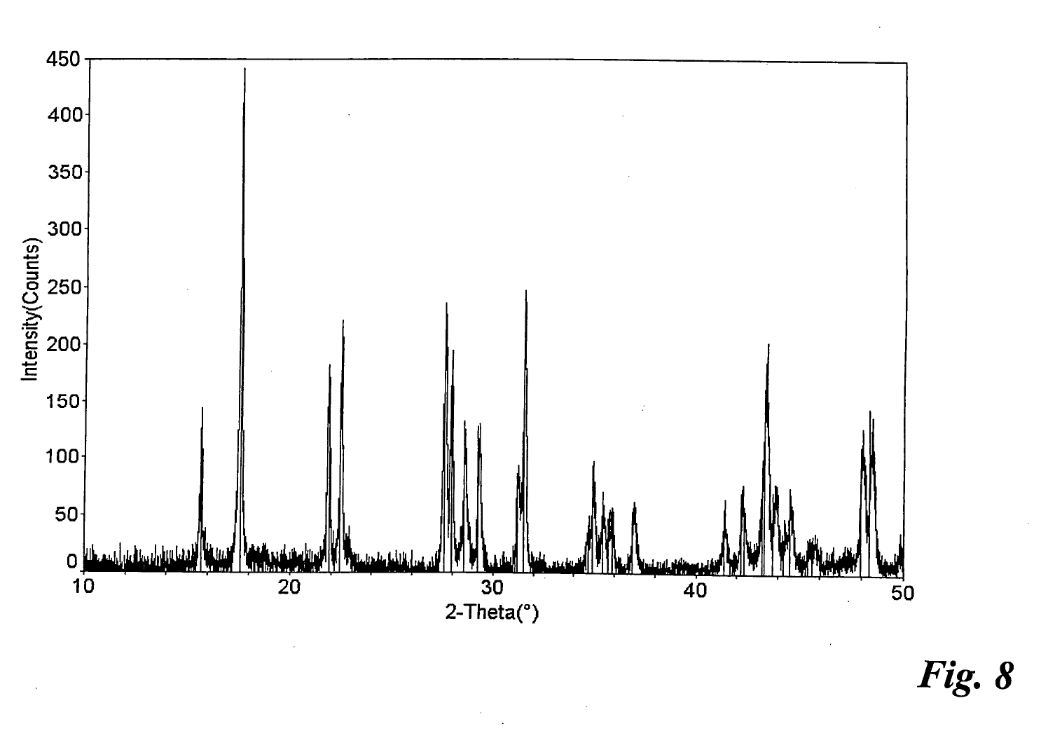

LaB₃O₆:La(O₂CCMe₃)₃ was slurried in tetrahydrofura to form a solution. B(OPh)₃ was added to the solution as a solid, and the reaction mixture stirred for 5 hr to form a resulting solution. The resulting solution was concentrated in vacuo to form a wax. The resulting wax was placed into an alumina crucible, and calcined at 550° C. for 10 hr and then at 750° C. for 10 hr to form a white precipitate. The resulting white precipitate was isolated and characterized by XRD. FIG. 8 is an x-ray diffraction pattern of crystalline inorganic particles 100. Using the Scherrer equation to fit the diffraction pattern results in an average crystallite size of 77 nm for the observed LaB₃O₆ powder.

### EXAMPLE 5

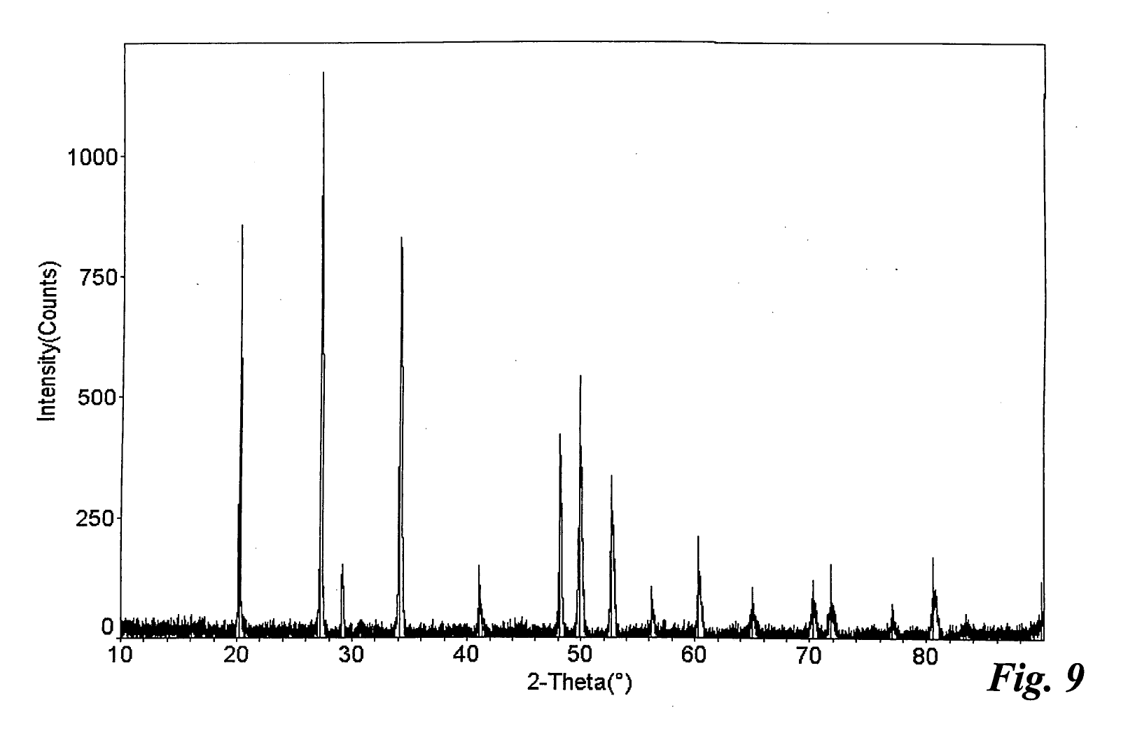

YBO₃. Yttrium 2-ethyl hexanoate and Europium 2-ethyl hexanoate were dissolved in tetrahydrofuran with gentle heating to form a solution. B(OPh)₃ was added to the solution as a solid, and the reaction mixture stirred for 3 hr to form a resulting solution. The resulting solution was concentrated in vacuo to form an oil. The resulting oil was placed into an alumina crucible, and calcined at 550° C. for 10 hr and then at 750° C. for 10 hr. The resulting white precipitate was isolated and characterized by XRD. FIG. 9 is an x-ray diffraction pattern of crystalline inorganic particles 100. Using the Scherrer equation to fit the diffraction pattern results in an average crystallite size of 83 nm for the observed YBO₃ powder.

While typical embodiments have been set forth for the purpose of illustration, the foregoing description should not be deemed to be a limitation on the scope of the invention. Accordingly, various modifications, adaptations, and alternatives may occur to one skilled in the art without departing from the spirit and scope of the present invention.

1. A method of making crystalline inorganic particles having an average size of up to about 200 nm,
wherein the crystalline inorganic particles comprises at least one crystalline inorganic chalcogenide and combinations thereof;
wherein each crystalline inorganic particle comprises at least one crystallite;
the method comprising the steps of:
i) providing at least one organometallic precursor, wherein the at least one organometallic precursor comprises at least one of a metal alkoxide, a metal carboxylate, and combinations thereof;
ii) decomposing the at least one organometallic precursor at a first temperature for a sufficient time to form an inorganic amorphous material; and
iii) crystallizing the inorganic amorphous material at a second temperature for a sufficient time to form a crystalline phase.

2. The method of claim 1, wherein the step of providing at least one organometallic precursor comprises providing a solution comprising the organometallic precursor and a solvent.

3. The method of claim 2, wherein the solvent comprises a non-aqueous solvent.

4. The method of claim 3, wherein the non-aqueous solvent comprises an aprotic solvent.

5. The method of claim 3, wherein the non-aqueous solvent comprises an organic solvent.

6. The method of claim 1, further comprising providing a surfactant to the organometallic precursor.

7. The method of claim 6, wherein the surfactant comprises an aprotic surfactant.

8. The method of claim 1, further comprising providing at least one promoter to the organometallic precursor.

9. The method of claim 8, wherein the at least one promoter comprises a nucleophilic promoter.

10. The method of claim 8, wherein the at least one promoter comprises an electrophilic promoter.

11. The method of claim 1, further comprising providing at least one dopant to the organometallic precursor.

12. The method of claim 11, wherein the at least one dopant comprises at least one of a metal and a chalcogen.

13. The method of claim 12, wherein the at least one dopant comprises a metal.

14. The method of claim 13, wherein the metal comprises at least one of an alkali metal, alkaline earth metal, transition metal, and rare earth metal.

15. The method of claim 11, wherein the at least one dopant comprises a luminescent dopant.

16. The method of claim 1, wherein the at least one organometallic precursor comprises a metal alkoxide.

17. The method of claim 16, wherein the metal alkoxide comprises M(OR)ₙX₍ₘ₋ₙ₎Lₚ wherein M is an electropositive element of Groups 1-15, each X is independently selected from a group consisting of O_{1/2}, F, Cl, Br, I, OR, O₂CR, NR₂, and R, each R is independently a hydrocarbyl group, each L is independently a Lewis base ligand, n is equal to ½ the oxidation state of the metal M in the product particle, m is equal to the oxidation state of M in the compound M(OCR)-ₙX₍ₘ₋ₙ₎Lₚ and p≧0.

18. The method of claim 17, wherein X is an alkoxide of the form OR wherein the alkoxide is selected from a group consisting of methoxide, ethoxide, i-propoxide, n-butoxide, t-butoxide, phenoxide, 2,6-dimethylphenoxide, trifluoromethoxide, trifluoroethoxide and hexafluoro-i-propoxide.

19. The method of claim 17, wherein X comprises NR₂

20. The method of claim 17, wherein the hydrocarbyl group comprises a monovalent, linear, branched, cyclic, or polycyclic group containing carbon and hydrogen atoms, the hydrocarbyl group optionally containing atoms in addition to carbon and hydrogen, atoms selected from Groups 15, and 16 of the Periodic Table and further containing C₁₋C₃₀ alkyl; C₁-C₃₀ alkyl substituted with one or more groups selected from C₁₋C₃₀ alkyl, C₃-C₁₅ cycloalkyl or aryl; C₃₋C₁₅ cycloalkyl; C₃₋C₁₅ cycloalkyl substituted with one or more groups selected from C₁₋C₂₀ alkyl, C₃-C₁₅ cycloalkyl or aryl; C₆-C₁₅ aryl; and C₆-C₁₅ aryl substituted with one or more groups selected from C₁-C₃₀ alkyl, C₃-C₁₅ cycloalkyl or aryl group; wherein aryl denotes a substituted or unsubstituted phenyl, naphthyl, or anthracenyl group.

21. The method of claim 1, wherein the at least one organometallic precursor comprises a metal carboxylate.

22. The method of claim 21, wherein the metal carboxylate comprises M(O₂CR)ₙX₍ₘ₋ₙ₎Lₚ wherein M is an electropositive element of Groups 1-15, each X is independently selected from a group consisting of O_{1/2}, F, Cl, Br, I, OR, O₂CR, NR₂, and R, each R is independently a hydrocarbyl group, each L is independently a Lewis base ligand, n is equal to ½ the oxidation state of the metal M in the product particle, m is equal to the oxidation state of M in the compound M(O₂CR)ₙX₍ₘ₋ₙ₎Lₚ and p≧0.

23. The method of claim 22, wherein X is an alkoxide of the form OR wherein the alkoxide is selected from a group consisting of methoxide, ethoxide, i-propoxide, n-butoxide, t-butoxide, phenoxide, 2,6-dimethylphenoxide, trifluoromethoxide, trifluoroethoxide and hexafluoro-i-propoxide.

24. The method of claim 22, wherein X comprises NR₂.

25. The method of claim 22, wherein the hydrocarbyl group comprises a monovalent, linear, branched, cyclic, or polycyclic group containing carbon and hydrogen atoms, the hydrocarbyl group optionally containing atoms in addition to carbon and hydrogen, atoms selected from Groups 15, and 16 of the Periodic Table and further containing C₁₋C₃₀ alkyl; C₁-C₃₀ alkyl substituted with one or more groups selected from C₁₋C₃₀ alkyl, C₃-C₁₅ cycloalkyl or aryl; C₃₋C₁₅ cycloalkyl; C₃₋C₁₅ cycloalkyl substituted with one or more groups selected from C₁₋C₂₀ alkyl, C₃-C₁₅ cycloalkyl or aryl; C₆-C₁₅ aryl; and C₆-C₁₅ aryl substituted with one or more groups selected from C₁-C₃₀ alkyl, C₃-C₁₅ cycloalkyl or aryl group; wherein aryl denotes a substituted or unsubstituted phenyl, naphthyl, or anthracenyl group.

26. The method of claim 1, wherein the at least one organometallic precursor is polymetallic.

27. The method of claim 25, wherein the crystalline inorganic particles have an average size in range from 40 nm to about 100 nm.

28. The method of claim 1, wherein the step of decomposing the at least one organometallic precursor at a first temperature comprises a first temperature which is greater than the second temperature of crystallizing the inorganic amorphous material.

29. The method of claim 1, wherein the step of decomposing the at least one organometallic precursor at a first temperature comprises a first temperature which is the same as the second temperature of crystallizing the inorganic amorphous material.

30. The method of claim 1, wherein the step of decomposing the at least one organometallic precursor at a first temperature comprises a first temperature which is less than the second temperature of crystallizing the inorganic amorphous material.

31. The method of claim 1, wherein the step of decomposing the at least one organometallic precursor comprises decomposing under an inert atmosphere.

32. The method of claim 1, wherein the crystalline phase of the crystalline inorganic particle is in a colloidal suspension.

33. The method of claim 1, wherein the crystalline inorganic chalcogenide comprises a crystalline inorganic oxide.

34. The method of claim 1, wherein the crystallites comprise an average crystallite size in a range from about 1 nm to about 80 nm.

35. The method of claim 34, wherein the crystallites comprise an average crystallite size in a range from about 4 nm to about 40 nm

36. The method of claim 1, wherein the crystalline inorganic particle at least partially comprises a part of at least one of a scintillator, phosphor, light absorber, and light scatterer.

37. Crystalline inorganic particles having an average size of up to about 200 nm,
wherein the crystalline inorganic particles comprise at least one of a crystalline inorganic oxide and a crystalline inorganic chalcogenide and combinations thereof;
wherein each crystalline inorganic particle comprises at least one crystallite;
made by a method comprising the steps of:
i) providing at least one organometallic precursor, wherein the at least one organometallic precursor comprises at least one of a metal alkoxide, a metal carboxylate, and combinations thereof;
ii) decomposing the at least one organometallic precursor at a first temperature for a sufficient time to form an inorganic amorphous material; and
iii) crystallizing the inorganic amorphous material at a second temperature for a sufficient time to form a crystalline phase.

38. The crystalline inorganic particles of claim 37, wherein the crystalline inorganic particles have an average size in range from 40 nm to about 100 nm.

39. The crystalline inorganic particles of claim 37, wherein the crystallites comprise an average crystallite size in a range from about 1 nm to about 80 nm.

40. The crystalline inorganic particles of claim 37, wherein the crystalline inorganic particles at least partially comprises a part of at least one of a scintillator, phosphor, light absorber, and light scatterer.
